(19) United States
(12) Patent Application Publication
(10) Pub. No.: US 2011/0283858 A1
(43) Pub. Date: Nov. 24, 2011

(54) CLAMPING DEVICE FOR A SAW BLADE

(76) Inventor: Hongtao Zhou, (US)

(21) Appl. No.: 13/103,168

(22) Filed: May 9, 2011

(30) Foreign Application Priority Data
May 18, 2010 (CN) 201010178036.0

(51) Int. Cl. B26D 7/26; B23P 11/00

(52) U.S. Cl. 83/698.11; 29/428

(57) ABSTRACT

The present application provides a clamping device for a saw blade having a main body with a saw blade slot for installing the clamped portion of the saw blade, a first locking element installed on the main body and a first reversion element for exerting a force on the first locking element. The clamping device for a saw blade may further comprise a second locking element installed on the main body having a second reversion element for exerting a force on the second locking element so that the second locking element tends to move toward the longitudinal axis of the saw blade slot. At the clamping location, the first and second locking elements clamp the saw blade. Using the saw blade clamping device of the present application results in a stable saw blade for sawing and greatly enhances sawing efficiency.

### CROSS-REFERENCE TO RELATED APPLICATIONS

This application claims priority to CN 201010178036.0, filed May 18, 2010, which is hereby incorporated by reference.

### FEDERALLY SPONSORED RESEARCH OR DEVELOPMENT

Not Applicable.

### TECHNICAL FIELD

The invention relates to a clamping device for a saw blade, in particular, to a clamping device for the saw blade of a reciprocating saw.

### BACKGROUND OF THE INVENTION

For clamping a saw blade on a reciprocating saw, there are various prior methods for clamping devices known to those in the market. The current devices for clamping a saw blade only allow for the wide face or the narrow face of the saw blade to be clamped by the clamping device. For example, U.S. Pat. No. 6,101,726 discloses a clamping device for a saw blade that clamps the narrow face of the saw blade, wherein a V-shaped slot is formed on the clamping element to ensure clamping the saw blade stably, and the swing of the saw blade in a direction perpendicular to the wide face of the saw blade is limited by the V-shaped slot. However, the mechanism merely limits the swing of the saw blade to some extent, and the saw blade could still have some swing in the direction perpendicular to the wide face of the saw blade during operation. As a result, when only the wide face or narrow face are clamped, the saw face is not stably clamped. Additionally, it is difficult to manufacture the V-shaped slot and has a high cost of manufacture.

### SUMMARY OF THE INVENTION

The present application is directed to providing a clamping device for a saw blade to more effectively provide stable clamping of the saw blade.

In order to solve the above-mentioned technical problem, the clamping device for a saw blade provided by the present application comprises a main body which is formed with a saw blade slot for installing the clamped portion of the saw blade, a first locking element installed on the main body, and a first reversion element for exerting a force to the first locking element so that the first locking element tends to move toward the longitudinal axis of the saw blade slot. The clamped portion of the saw blade may have a wide face and a narrow face. The clamping device for a saw blade also may have a second locking element installed on the main body, and a second reversion element for exerting a force to the second locking element so that the second locking element tends to move toward the longitudinal axis of the saw blade slot, and at the clamping location, the first and second locking elements respectively clamp the narrow face and wide face of the clamped portion of the saw blade.

The present application further provides a method of installing and clamping the saw blades by using the clamping device for a saw blade. First, the first locking means is driven to move relative to the main body and away from the longitudinal axis of the saw blade slot. The second locking element is driven to move relative to the main body and away from the longitudinal axis of the saw blade slot. The clamped portion of the saw is inserted into the saw blade slot and the first and second locking elements are loosened so that the reversion force exerted to the first and second locking element by the first and second reversion elements drives the first and second locking elements to respectively move toward the longitudinal axis of the saw blade slots until the clamp is in a locking position.

Using the clamping device for a saw blade of the present application can achieve the stable sawing of the saw blades, and greatly enhance the sawing efficiency.

### BRIEF DESCRIPTION OF THE DRAWINGS

To understand the present application, it will now be described by way of example, with reference to the accompanying drawings in which:

FIG. 1 is a plan view of a clamping device for a saw blade according to the present application;

FIG. 2 is a plan view of the clamping device for a saw blade in FIG. 1, wherein the device is rotated 90′;

FIG. 3 is a sectional view of the clamping device for a saw blade taken along the Line A-A in FIG. 1;

FIG. 4 is a enlarged view of the clamping device for a saw blade at A in FIG. 3;

FIG. 5 is a sectional view of the clamping device for a saw blade taken along the Line B-B in FIG. 2;

FIG. 6 is an enlarged view of the clamping device for a saw blade at B in FIG. 3; and,

FIG. 7 is an exploded view of a clamping device for a saw blade according to the present application.

### DETAILED DESCRIPTION

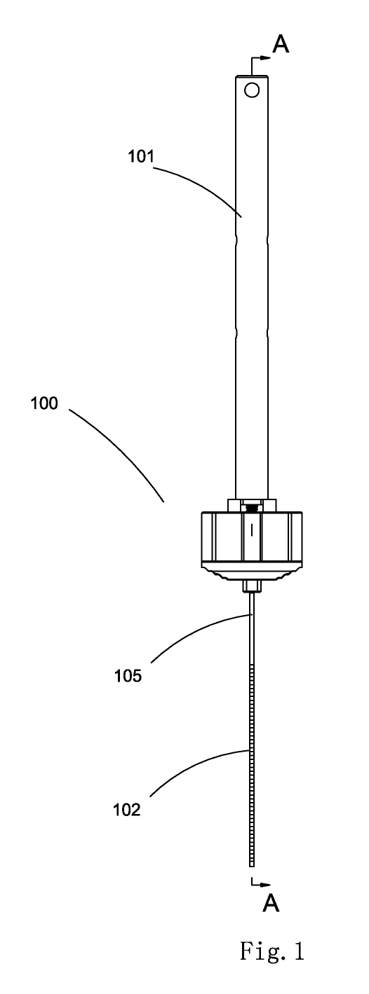

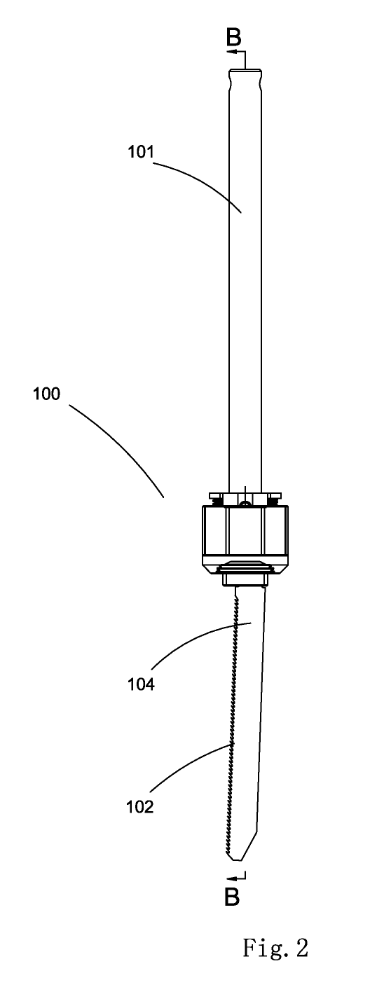

As shown in FIGS. 1-2, the clamping device for a saw blade 100 of the present application is fixedly installed to the reciprocating rod 101 of the reciprocating saw (not shown) via a pin 103. The clamped portion 108 of the saw blade 102 is installed into the clamping device for a saw blade 100, and the clamped portion 108 of the saw blade 102 has a wide face 104 and a narrow face 105.

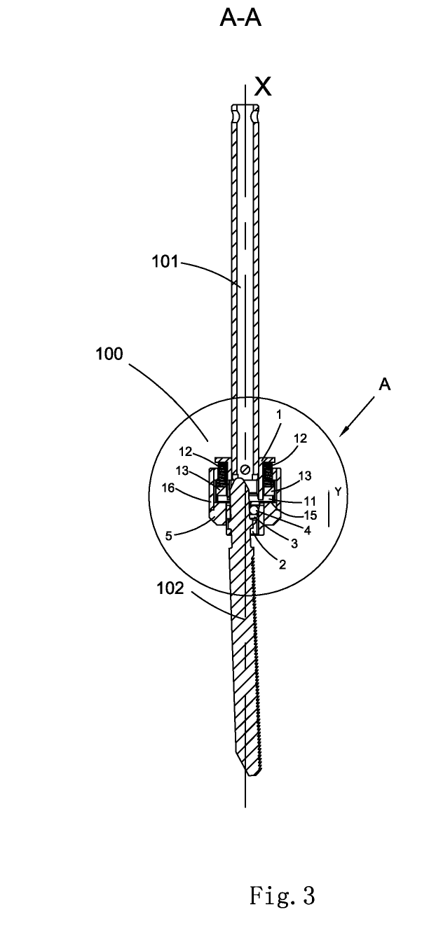

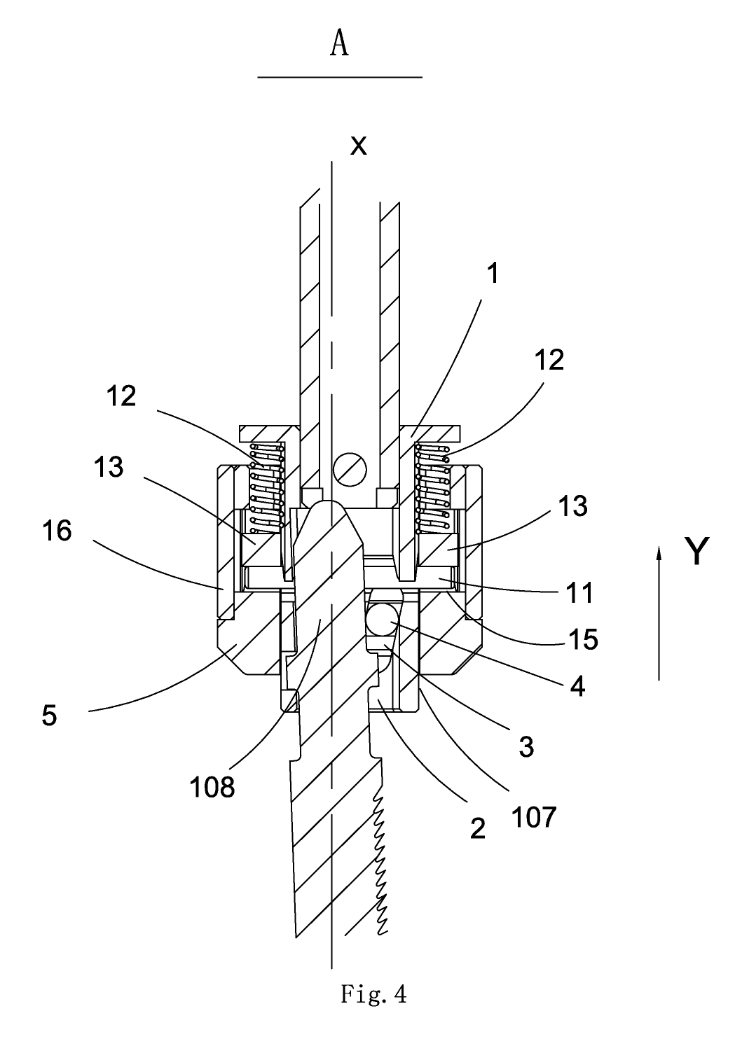

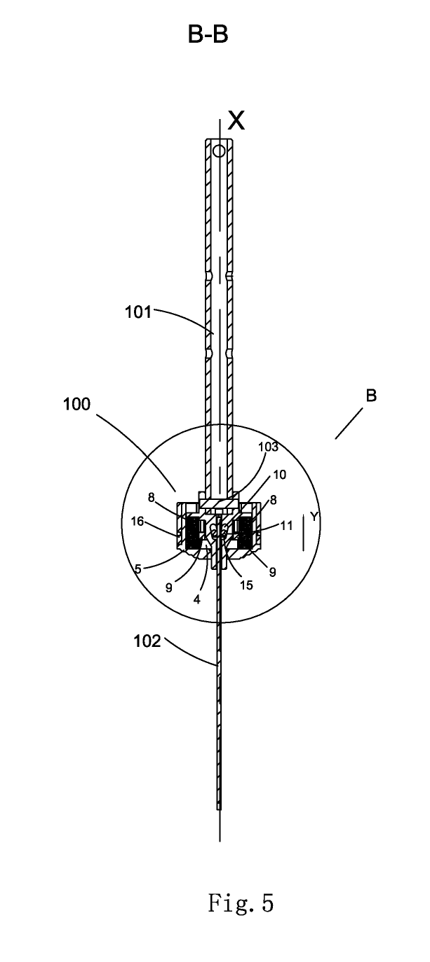

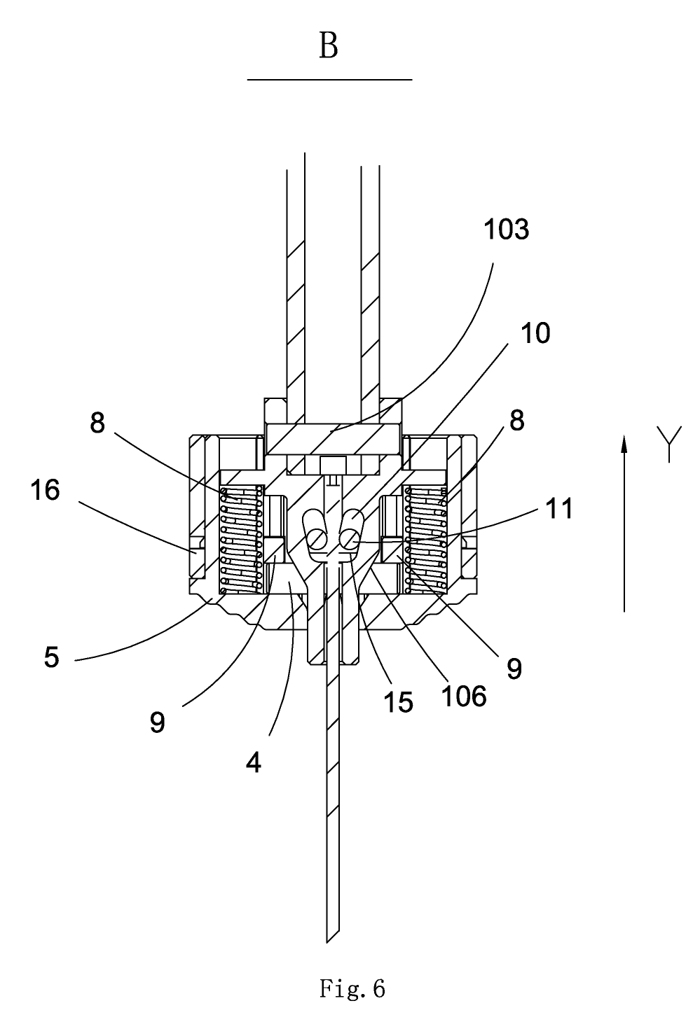

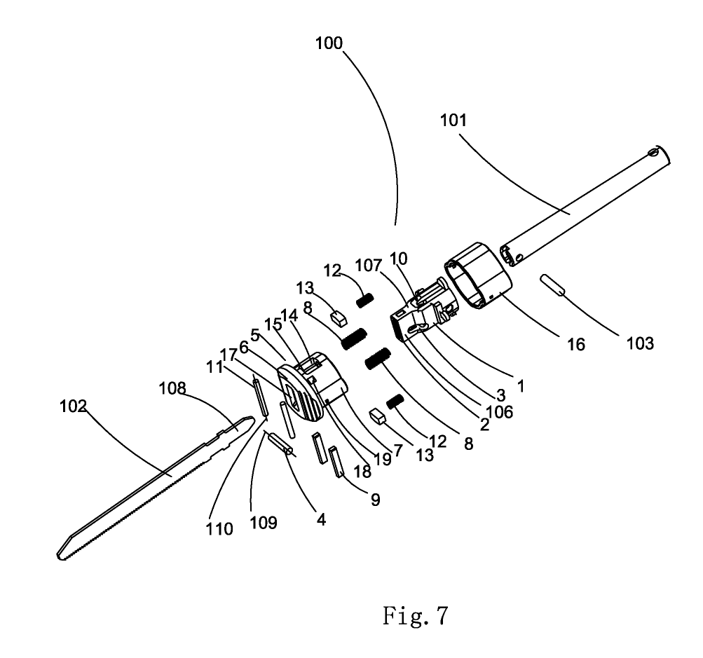

As shown in FIGS. 2-7, the clamping device for a saw blade 100 further comprises a main body 1, in which a saw blade slot 2 for receiving the saw blade is formed. The saw blade slot 2 has a longitudinal axis X, and the clamped portion 108 of the saw blade 102 can be inserted into the saw blade slot 2. The main body 1 comprises a first side wall 106 and an adjacent second side wall 107. A first slot is formed on the first side wall 106. The first slot is preferably an inclined slot 3, which is formed with a certain angle with respect to the extending direction of the longitudinal axis X of the saw blade slot. The inclined slot 3 is in communication with the saw blade slot 2. A first locking element, preferably a cylindrical pin 4, is installed in the inclined slot 3 and can move therein. The first locking element has a first center line 109. A clamping collar 5 is composed of a base 6 and a side wall 7. An opening 17 is formed on the base 6. The first reversion element is installed between the main body 1 and the clamping collar 5 of the base 6. The first reversion element 8 is preferably a compression spring. A pair of fixing pins 9 are fixedly installed on the clamping collar 5 through the holes 18, 19 on the side wall of the clamping collar 5. The cylindrical pin 4 is at least partially located between the base 6 of the clamping collar 5 and the fixing pin 9, and the distance between the fixing pin 9 and the base 6 is slightly greater than the diameter of the cylindrical pin 4. When the clamping collar 5 overcomes the spring force from the compression spring 8 and slides relative to the main body 1 along the direction of arrow Y as shown in the figures, the cylindrical pin 4 can slide together with the clamping collar 5 relative to the main body 1 and meanwhile move relative to the base 6 of the clamping collar 5 under the action of the inclined slot 3.

As shown in FIGS. 2-7, a second slot is formed on the second side wall 107 of the main body 1. The second slot is preferably an inclined slot 10, which is formed with a certain angle with respect to the extending direction of the longitudinal axis X of the saw blade slot. The inclined slot 10 may be in communication with the saw blade slot 2. A second locking element, preferably a cylindrical pin 11, is installed in the inclined slot 10. The second locking element has a second center line 110, which is preferably perpendicular to the first center line 109, so that the first clamping element and the second clamping element are preferably arranged to be perpendicular to each other. The second reversion element is preferably a compression spring 12, one end of which is installed on the main body 1, and the other end of which exerts a pressure to a press block 13. The press block 13 may be pressed on the second locking element (e.g. the cylindrical pin 11). Under the action of the spring force of the compression spring 12, the cylindrical pin 11 tends to move toward the direction of the clamping the saw blade in the inclined slot 10. In addition, an opening 14 is formed on the side wall 7 of the clamping collar 5, which includes a bottom face 15 and accommodates the compression spring 12 and the press block 13. A part of the cylindrical pin 11 extends into the opening 14. In addition, a sheath 16 is pressedly installed on the clamping collar 5 by the interference fit. The opening 14 is covered by the sheath 16 so as to ensure the stable installation of the press block 13 on one hand and prevent dust from entering into the locking elements on the other hand. Moreover, the compression spring 12 can act on the cylindrical pin 11 directly but not through the press block 13. When the compression spring 8 and the compression spring 12 are in a neutral state, a clearance is preferably retained between the bottom face 15 of the opening 14 and the cylindrical pin 11, so as to ensure that the cylindrical pins 4 and 11 can clamp the narrow face 105 and the wide face 104 of the saw blade respectively.

When a operator needs to install the saw blade 102, the clamping collar 5 is driven to move relative to the main body 1, and the clamping collar overcomes the spring force of the compression spring 8 to drive the cylindrical pin 4 in the first slot 3 to move in a direction away from the longitudinal axis of the saw blade slot 2. At this time, the cylindrical pin 4 is unfastened, and the clamping collar 5 is continuously driven. The bottom face 15 of the opening 14 formed by the clamping collar 5 contacts with the cylindrical pin 11, and overcomes the spring force of the compression spring 12 and drives the cylindrical pin 11 in the second slot 10 to move in a direction away from the longitudinal axis of the saw blade slot 2. At this time, the cylindrical pin 11 is unfastened. The clamped portion 108 of the saw blade 12 is inserted into the saw blade slot 2 though the opening 17 on the base 6. The clamping collar 5 is unfastened, and under the action of the spring force of the compression spring 12, the cylindrical pin 11 moves in a direction toward the longitudinal axis of the saw blade slot 2 in the second slot 10. When in the locking position, the wide face of the clamped portion 108 of the saw blade 102 is clamped. Under the action of the spring force of the compression spring 8, the cylindrical pin 4 moves toward the longitudinal axis of the saw blade slot 2 in the first slot 3. When in the locking position, the narrow face of the clamped portion 108 of the saw blade 102 is clamped. In addition, in the present utility model, it can also be the first locking element to clamp the wide face of the saw blade while the second locking element clamps the narrow face of the saw blade. The first locking element can include two or more cylindrical pins. For example, two cylindrical pins are used to clamp the two narrow faces of the saw blade or two cylindrical pins are used to clamp one narrow face of the saw blade. Also, the second locking element can include two or more cylindrical pins. In other embodiments, the first locking element and the second locking element can also be other suitable configuration, which is not limited to the cylindrical pin.

In conclusion, the above descriptions and the accompanying drawings illustrate several embodiments of the present application. By the understanding of the above descriptions and the accompanying drawings, simple alternations to the components of the present application by persons skilled in the art are considered to be within the scope sought for protection by the present application.

What is claimed is:

1. A clamping device for a saw blade, comprising:
a main body having a saw blade slot for receiving a clamped portion of a saw blade;
a first locking element installed on the main body;
a first reversion element for exerting a force on the first locking element so that the first locking element tends to move towards a longitudinal axis of the saw blade slot, wherein the clamped portion of the saw blade has a wide face and a narrow face;
a second locking element installed on the main body; and a second reversion element for exerting a force on the second locking element so that the second locking element tends to move toward the longitudinal axis of the saw blade slot, and at a clamping location, the first and second locking elements respectively clamp the narrow face and the wide face of the clamped portion of the saw blade.

2. A clamping device for a saw blade according to claim 1, wherein the first locking element has a first center line, and the second locking element has a second center line perpendicular to the first center line.

3. A clamping device for a saw blade according to claim 1, wherein the first locking element and the second locking element are arranged to be perpendicular to each other.

4. A clamping device for a saw blade according to claim 1, wherein the main body comprises a first side wall on which a first slot is formed and a second side wall on which a second slot is formed, and the first locking element is partially located in the first slot, the first slot is in communication with the saw blade slot, the second locking element is partially located in the second slot, and the second slot is in communication with the saw blade slot.

5. A clamping device for a saw blade according to claim 4, wherein the clamping device for a saw blade further comprises a clamping collar, the first locking element being connected to the clamping collar.

6. A clamping device for a saw blade according to claim 5, wherein the clamping collar has a opening including a bottom face, and wherein when the first reversion element and the second reversion element are in a neutral state, the bottom face is not in contact with the second locking element.

7. A clamping device for a saw blade according to claim 5, wherein one end of the second reversion element acts on the main body, and the other end of the second reversion element acts on a press block, the press block acting on the second locking element and being located in the opening.

8. A clamping device for a saw blade according to claim 1, wherein the first locking element includes at least one cylindrical pin; the second locking element includes at least one cylindrical pin; and the first reversion element and the second reversion element are compression springs.

9. A clamping device for a saw blade according to claim 8, wherein one end of the first reversion element acts on the main body, and the other end of the first reversion element acts on the first locking element and one end of the second reversion element acts on the main body, and the other end of the second reversion element acts on the second locking element.

10. A method of installing and clamping saw blades by using a clamping device for a saw blade, the clamping device for a saw blade comprising:
a main body formed with a saw blade slot for installing a clamped portion of a saw blade, a first locking element installed on the main body, a first reversion element for exerting a force to the first locking element so that the first locking element tends to move toward the longitudinal axis of the saw blade slot;
a second locking element installed on the main body and a second reversion element exerting a force to the second locking element so that the second locking element tends to move toward the longitudinal axis of the saw blade slot, wherein the clamped portion of the saw blade has a wide face and a narrow face and the saw blade slot has a longitudinal axis, the method comprising the following steps:
driving the first locking element to move relative to the main body and away from the longitudinal axis of the saw blade slot;
driving the second locking element to move relative to the main body and away from the longitudinal axis of the saw blade slot;
inserting the clamped portion of the saw blade into the saw blade slot;
loosening the first and second locking elements,
a reversion force being exerted on the first and second locking element by the first and second reversion elements causing the first and second locking elements to respectively move toward the longitudinal axis of the saw blade slots until a locking position is reached.

11. The method of installing the saw blade according to claim 10, wherein the first and second locking elements respectively clamp the narrow face and the wide face of the clamped portion of the saw blade.

12. The method of installing the saw blade according to claim 11, wherein the first locking element is arranged to be perpendicular to the second locking element.

13. The method of installing the saw blade according to claim 12, wherein the clamping device further comprises a clamping collar slidable along the direction of the longitudinal axis of the saw blade slot with respect to the main body.
